(19) United States
(12) Patent Application Publication
(10) Pub. No.: US 2012/0230653 A1
(43) Pub. Date: Sep. 13, 2012

(54) METHOD AND SYSTEM FOR DIGITAL CINEMA PRESENTATION

(75) Inventor: William Gibbens Redmann, Glendale, CA (US)

(73) Assignee: Thomson Licensing, Boulogne-Billancourt (FR)

(21) Appl. No.: 13/510,075

(22) PCT Filed: Nov. 17, 2009
(86) PCT No.: PCT/US09/06156

§ 371 Date: May 16, 2012

(51) Int. Cl. H04N 9/80

(52) U.S. Cl. 386/241; 386/E05.003

(57) ABSTRACT

A method and system for digital cinema presentation are disclosed. The method provides for automatic comparison of a playlist against at least one attribute relating to digital content, and automatically skipping one or more compositions during playout of content in the playlist based on the comparison results.

### TECHNICAL FIELD

This invention relates to a method and system for digital cinema presentation.

### BACKGROUND

In digital cinema presentations, a presentation or show is played out by executing a series of instructions according to certain playlists. For example, a composition playlist (CPL) is a textual list that specifies the track files required in a composition, and how the elements are played back in a presentation. A show playlist (SPL) is a file or playlist that instructs which compositions are to be played, and in what order, in a show. To reduce an exhibitor's labor expended in the creation of each SPL, a “pack playlist” (PPL) containing sequences of compositions (e.g., relating to certain types of content such as a trailer pack or advertisement pack) may be created and saved for later use. Such PPLs may be created or updated regularly by the exhibitor for use in new and/or pre-existing SPLs.

Currently, there is a standard for one form of a CPL, e.g., published by the Society of Motion Picture and Television Engineers (SMPTE) of White Plains, New York, as “SMPTE 0429-7-2006 D-Cinema Packaging—Composition Playlist”. While standards for SPL and PPL are still being developed by SMPTE, one SPL format—the Synchronized Multimedia Integration Language (SMIL) 1.0 Specification file format, has been published by World Wide Web Consortium and represented in the United States by the Massachusetts Institute of Technology, Office of Sponsored Programs, Cambridge, Mass.

Various modern implementations of show playlists are provided by digital cinema equipment manufacturers, including for example, Doremi Cinema, LLC of Burbank, Calif. and Dolby Laboratories of San Francisco, Calif., which presently support proprietary SPL formats, but both employ the SMPTE CPL standard.

Although pre-packaged SPLs are provided to exhibitors or theatres by content distributors, some exhibitors or theatres may have policies or obligations that restrict which compositions are allowed to be shown. For example, a theatre with a contract relating to a first brand of merchandise may be obligated not to show advertisements related to a second brand of merchandise, or other competing brands.

In other examples, a theatre may have a policy against showing a trailer for a movie with a restricted rating (R-rated) in a main feature that has a parental guidance rating (PG-rated), or a policy that allows the trailer to be shown if the trailer itself has been approved for general (G-rated) audiences. Alternatively, an exhibitor may simply object to a particular trailer or advertisement, and chooses not to present that composition to audiences.

According to conventional operation of PPLs or SPLs, if one or more CPLs in a PPL or SPLs violate an exhibitor's policies, obligations, or taste, the exhibitor has three choices. First, the exhibitor may omit any PPL that contains at least one offending CPL from use in SPLs. This is undesirable because the exhibitor foregoes the revenue and marketing value of otherwise permissible CPLs in the PPL.

Second, the exhibitor may create a new, custom PPL that omits the offending CPLs. While effective, this requires the exhibitor to regularly edit PPLs, which may be a task not normally undertaken by the exhibitor. Furthermore, if the original PPL is updated, additional time and efforts are required for updating the custom PPL.

Third, the exhibitor may add the non-offending CPLs from the PPL, unbundled, as individual CPLs into the exhibitor's SPLs. However, this option effectively eliminates the benefits of using PPLs, and if the offending PPL is subsequently updated, there is no easy mechanism to identify or automatically update the SPLs that include the unbundled, non- offending CPLs. Instead, every SPL will need to be edited.

### SUMMARY OF THE INVENTION

Embodiments of the present invention relate to a method and system for presenting digital content, e.g., in a digital cinema, by automatically comparing a playlist with at least one attribute related to an operating rule or policy. If the playlist contains any composition playlist (or composition) that matches the at least one attribute or satisfies the rule, the composition will automatically be excluded from presentation. Implementations according to present principles greatly facilitates playlist processing, e.g., by avoiding the need to delete an entire playlist package, or manually editing playlists or rebuilding new packages with only acceptable compositions.

One embodiment provides a method for use in a digital cinema, the method includes providing at least one attribute relating to digital content, automatically comparing the at least one attribute with a digital cinema playlist having references to one or more compositions, and automatically skipping at least one composition during playout of content in the digital cinema playlist in accordance with results of the comparing step.

Another embodiment provides a digital cinema system, which includes a storage device for storing at least one attribute relating to digital content, and a processor configured for automatically performing a comparison of the at least one attribute with a playlist having references to one or more compositions, and automatically skipping at least one composition during playout of content in the playlist in accordance with results of the comparison.

Yet another embodiment provides a computer readable medium having stored instructions that, when executed, causes a method to be performed for processing one or more playlists in accordance with one or more embodiments described herein.

### BRIEF DESCRIPTION OF THE DRAWING

The teachings of the present invention can be readily understood by considering the following detailed description in conjunction with the accompanying drawings, in which:

FIG. 1 is a schematic illustration of a system suitable for implementing embodiments of the present principles;

FIG. 2 is an illustration of a portion of a show playlist;

FIG. 3 is an illustration of a portion of a pack playlist;

FIG. 4 is an illustration of a portion of a composition playlist;

FIG. 5 is a forbid list according to one embodiment of the present principles;

FIG. 6 is a flowchart illustrating one embodiment of the present principles; and

FIG. 7 is a flowchart illustrating another embodiment of the present principles.

To facilitate understanding, identical reference numerals have been used, where possible, to designate identical elements that are common to the figures.

### DETAILED DESCRIPTION

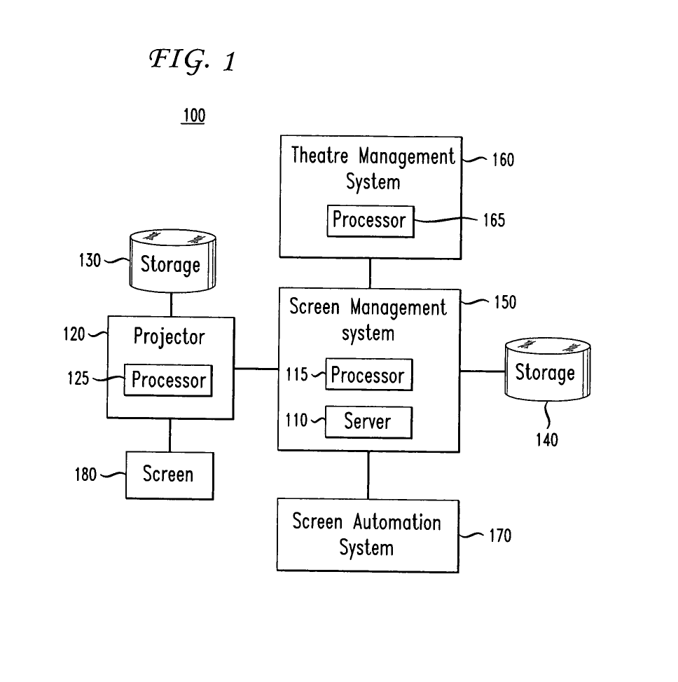

FIG. 1 depicts one embodiment of a digital cinema system 100 that can be used for implementing embodiments in accordance with the present principles. The digital cinema system 100 includes a content server 110, a digital projector 120, and one or more storage devices 130, 140. In one embodiment, the content server 110 is a part of a screen management system (SMS) 150. In this case, the system 100 also includes a theatre management system (TMS) 160 and a screen automation system (SAS) 170.

The TMS 160, with at least one processor 165, manages the overall workflow and equipment within a theatre; and provides control, supervision and report status on the theatre equipment. In general, a movie theatre can have multiple auditoriums, each with its own screen management and automation systems, digital cinema projector and associated screen. One example of a TMS is TMS v3.0, created and marketed by Technicolor Digital Cinema, of Burbank, Calif.

In a TMS, exhibitors may create show playlists (SPLs) each containing a sequence of composition playlists (CPLs), which includes sound and/or picture assets, and data relating to how these assets are to be presented. These SPLs and the CPLs referenced by the SPLs are distributed to various players, e.g., auditoriums in one or more theatres, and each player is instructed or scheduled to play the SPL for the theatre's audience.

Content server 110 contains instructions and data for controlling both the digital projector 120 and the SAS 170. A decoder (not shown) is also included in the server 110 for responding to commands received from the TMS 160. At least one processor (e.g., processor 115) associated with, or provided in the server 110, is used for processing playlists according to embodiments of the present invention. Examples of digital cinema server manufacturers include Dolby Laboratories in San Francisco, Calif.; Doremi Digital Cinema in Burbank, Calif.; and Eastman Kodak in Rochester, N.Y.; among others.

Digital cinema server 110, which has at least read access to a storage device 140 (may be external or internal to the server), is configured for retrieving a composition from storage and decoding picture and audio essence. During the playout of digital content, picture essence and timing information relating to the presentation of digital content are provided by the server 110 to the projector 120. Images are generated from the picture essence by a processor 125 associated with the projector 120 and projected onto a screen 180. Digital cinema projectors are available from several manufacturers, e.g., Barco Media & Entertainment, LLC, in Rancho Cordova, Calif.; NEC Corporation of America in Irving, Tex.; and Sony Electronics, Inc. in Park Ridge, N.J.; among others. Audio essence is provided by the server 110 to an audio reproduction chain (not shown), which delivers the audio component associated with or accompanying the picture essence to the audience.

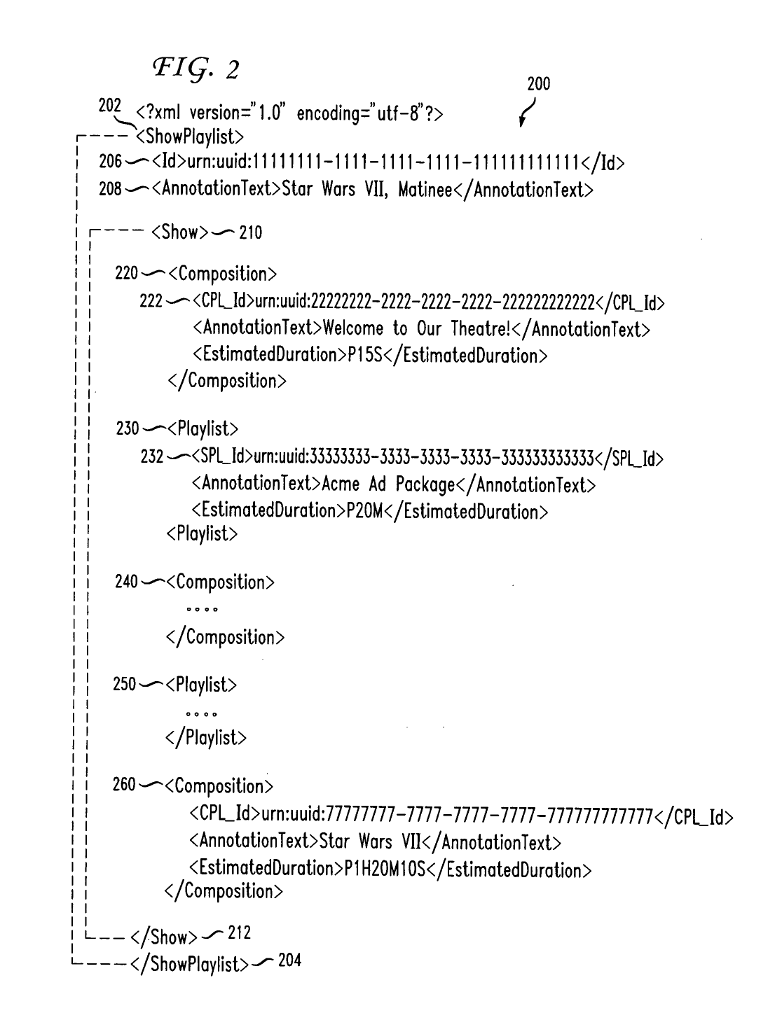

FIG. 2 illustrates a portion of a show playlist 200 represented as an XML document. Show playlist 200 includes a single ShowPlaylist element, bounded by tags 202 and 204. Show playlist 200 has a unique ID 206, and is annotated with a human-readable comment 208, which suggests that this particular show playlist is for the movie “Star Wars VII” and is for a matinee performance. Although the show playlist is meant as instructions for a machine, e.g., processor in a digital cinema server, the annotation text allows a person to discern the gist of the show.

Show playlist 200 also includes a single show element beginning at tag 210 and ending at tag 212. The show element contains a sequence of compositions (e.g., advertisements, trailers, features, policy statements, and so on), pack playlists, and markers for use with automation. Throughout this discussion, no markers are shown, for clarity.

FIG. 2 shows three references to compositions 220, 240 and 260, and two references to pack playlists (PPL) 230 and 250. Although there are different implementations of PPLs, the SPL and all possible forms of PPLs basically resolve to a finite sequence of compositions. Some details of a few compositions are shown for illustrative purposes, while others are omitted for clarity.

Each composition reference 220, 240 and 260 identifies its corresponding composition using a unique identifier, and contains other information regarding the referenced composition. For example, composition reference 220 has a CPL_Id 222 whose unique identifier is “22222222-2222-2222-2222-222222222222”. This will be recognized as a globally unique identifier (GUID) used to unambiguously identity the composition desired.

In this example, the show with composition reference 220 is an introduction, as suggested by the annotation text “Welcome to Our Theatre!”. This runs for about 15 seconds, as shown by the EstimatedDuration element of composition 220.

This is followed by playlist reference 230 (an advertisement package), composition reference 240, playlist reference 250, and composition reference 260. Elements in composition or playlist references 240 and 250, e.g., respective CPL or SPL identifiers, annotation texts, and estimated durations, are omitted for clarity's sake.

Similar to the composition reference, each PPL reference also has its own unique identifier (e.g., a show playlist ID) and other information relating to the referenced SPL, e.g., PPL reference 230 has a SPL_Id 232, annotation text and estimated duration.

Composition reference 260 is directed to the feature itself, which, in this example, is expected to run for just over one hour and twenty minutes. Note that it is the title or annotation text of the feature composition 260 that is replicated and/or augmented in the annotation text 208 of SPL 200.

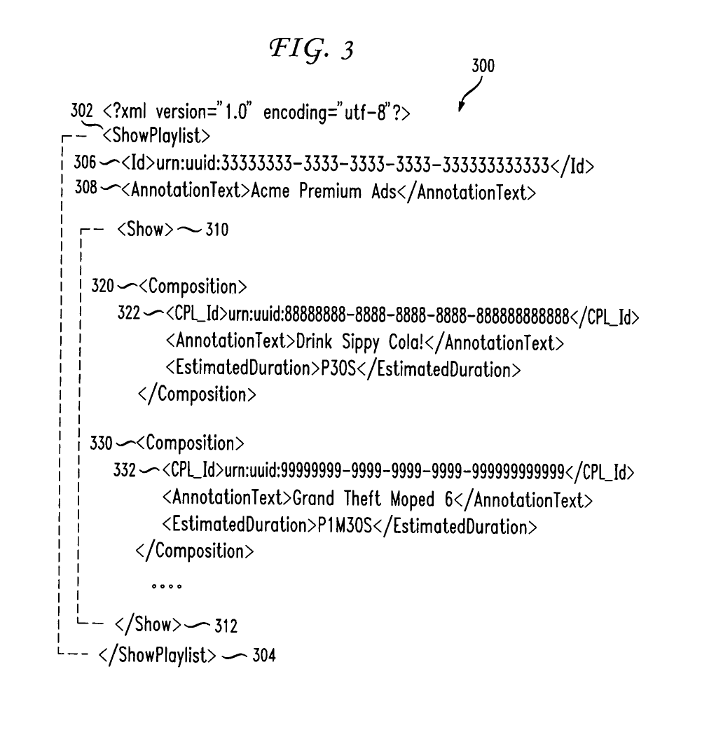

Together, the component elements between show list tags 210 and 212 provide the highest-level view of the show defined by SPL 200. A more detailed illustration of the pack playlists referred to by the element 230 is shown in FIG. 3.

FIG. 3 illustrates a portion of a pack playlist (PPL) 300. For purposes of this description, the schema of the pack playlist is presumed to be essentially identical to that of the show playlist, without broaching the issue of whether or not a PPL may reference another

PPL within its show list.

In this example, PPL 300 is bounded by show playlist tags 302 and 304. ID 306 corresponds to the SPL_Id reference 232 in SPL 200. Thus, PPL 300 is the advertising package identified by playlist reference 230 in SPL 200.

Tags 310 and 312 bound the show list enumerating the contents of the show provided by PPL 300. Two composition references 320 and 330 are shown, each with its own composition IDs 322 and 332, respective annotation texts and estimated durations.

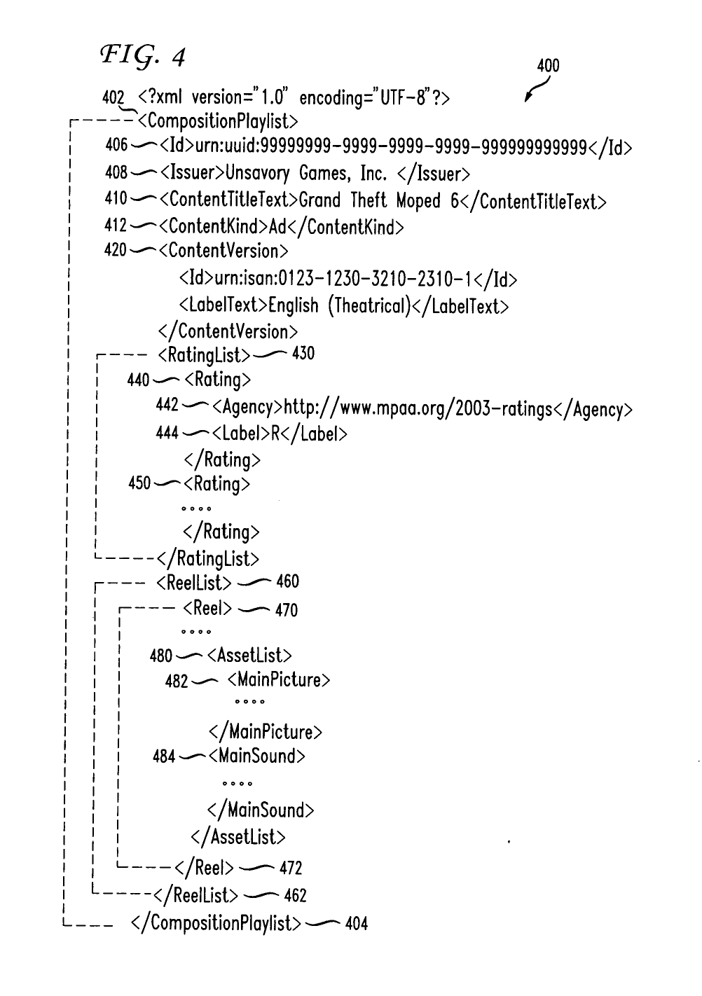

FIG. 4 illustrates a portion of a composition playlist (CPL) 400 that is compatible with most modern commercial digital cinema servers, and may be referenced within most proprietary digital cinema SPLs of today as well as those proposed for standardization.

CPL 400, bounded by tags 402 and 404, has an ID 406 corresponding to CPL_ID 332 in composition reference 330 of PPL 300. CPL 400 may further include elements indicating an issuer 408, content title text 410, a content kind 412, a content version identifier (or ID) 420, a list of ratings 430, and the sequence of content to be presented between reel list tags 460 and 462.

Content version ID 420 may be used as an alternate mechanism for identifying this CPL, but allowing automatic replacement by a more recent version. Such identifiers other than a CPL ID (or analogously an SPL ID) may be used to reference compositions or pack playlists. Content version identifier 420 may be common to multiple earlier and/or subsequent revisions of a CPL so that a reference to a content version ID is able to summon the most current available version of a CPL.

It is possible that content version ID 420 may become available long before a film has finished production or entered distribution. Studios may also employ a ‘booking number’ to specify which language version with which subtitles (if any) that a theatre is contracting to exhibit. This booking number typically pre-dates the actually film print to be distributed. It is possible that, in the future, the extant notion of the booking number becomes embodied in the content version ID, and schedules and show playlists 100 may be readied in advance of actually receiving the associated content. Further, in cases where a studio finds it necessary to deploy a corrected or updated composition, playlists and schedules may be configured to accommodate the change without manual intervention.

In the example of FIG. 4, rating list 430 contains two ratings elements 440 and 450. The first rating 440 is that of the Motion Picture Association of America, as indicated by agency element 442 and their rating of the content (“R”) of this CPL is contained in label element 444. The second rating 450 may refer to a different agency with a different rating (not shown). By providing more than one rating elements in the rating list 430, a single CPL 400 may be used across multiple jurisdictions, and each exhibitor may employ the rating of an appropriate agency.

The reel list, bounded by tag 460 to tag 462, includes a single reel between tags 470 and 472. Aside from its identifier and annotation text (not shown), each reel includes an asset list 480, which typically includes a main picture element 482 and a main sound element 484 that identifies a primary language of the dialog that it contains. Together, the picture and sound elements 482 and 484 identify which picture and sound media should be played together, and exactly how they are to be synchronized. Details within reel 470 are omitted for purpose of clarity.

The playlists shown in FIGS. 2-4 (with the exception of nomenclature changes) are similar in format to many currently available proprietary show playlists, as well as those being discussed in standards organizations such as SMPTE, except that the inclusion of PPL references 230 and 250 in SPL 200 is not yet widely implemented. Thus, future development may include providing a standard for a PPL within a SPL, permitting a SPL to reference other SPLs, or to reference other SPLs and/or PPLs. In any of these cases, the SPL can be transformed into a flattened sequence of CPLs. Throughout this discussion, a reference to PPL may also mean SPL in the case where a recursive form of the SPL (i.e., an SPL is a list of one or more of the group consisting of an SPL and a composition) is used to provide the PPL functionality. In general, embodiments of the present principles can be applied to playlists that may or may not exist in proprietary or standard formats.

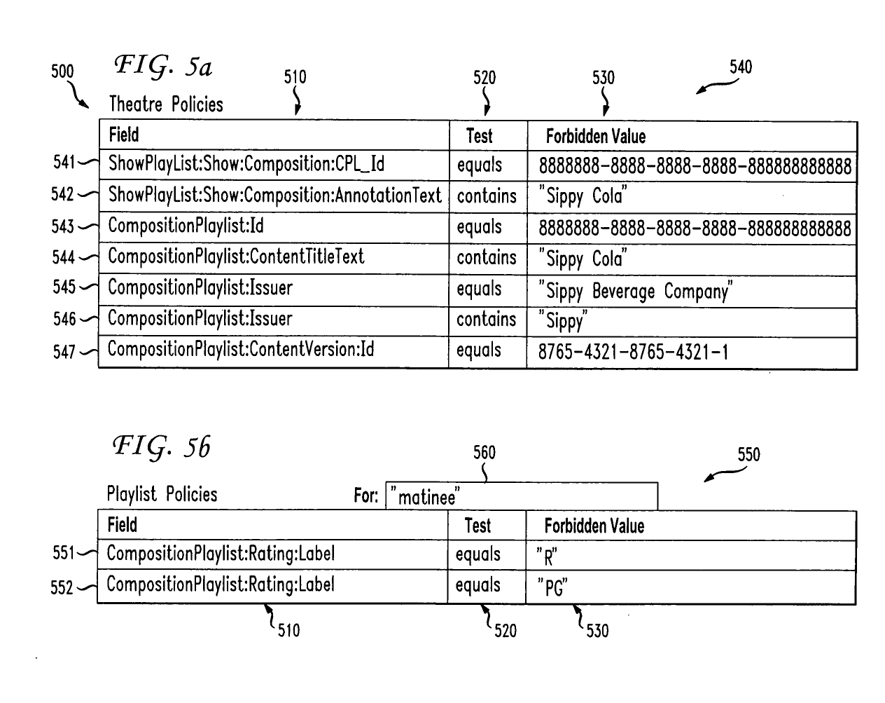

FIG. 5 illustrates an example of a forbid list 500 of the present invention, which is used to identify certain compositions in a playlist (e.g., as received from the content provider or distributor) to be excluded from being played out. Entries in the forbid list 500 are used to represent one or more rules embodying certain policies. Based on these rules, a content display system can automatically reject or skip certain content or compositions according to the policies. In one example, the content display system is a digital cinema, and the policies may be set by the exhibitors, content providers, or both.

The playlist (including all compositions referenced directly or indirectly in the playlist) is compared with certain attributes in the forbid list. Based on the comparison results, one or more compositions matching at least one attribute of the forbid list are skipped during playout of the original playlist. The comparison and skipping of the composition are done automatically by one or more processors, e.g., in the digital cinema server and/or theatre management system, without intervention by a person. In the context of this discussion, a composition refers to a collection of files that make up a movie, trailer, advertisement, and so on.

In this example, the forbid list 500 has three types of entries or items represented in columns 510, 520 and 530, respectively. Column 510 is a field that includes at least one element of a show playlist, pack playlist, or composition playlist. Column 530 contains at least one attribute, also referred to as a forbidden value, against which the contents of a corresponding element (e.g., in the same row) in field column 510 will be compared or tested. Test column 520 identifies one or more comparison tests to be performed on the elements in column 510, which may be represented as a binary comparison operator (e.g., equals, does not equal, contains, does not contain, greater than, less than, etc.) or other functions that return a true or false value.

If a test or comparison between an item in field 510 and its corresponding attribute in column 530 returns a “true” value, the item or composition containing the item in the field column 510 is referred to as matching the forbid value or attribute, and the composition will be rejected by that row of forbid list 500.

For illustrative purposes, forbid list 500 is shown to have a section 540 representative of theatre policies applicable to all playlists (e.g., SPLs, PPLs, and CPLs), and at least one section 550 containing policies each of which is applicable to only some of the playlists.

In exemplary theatre policies section 540, rows 541-546 represent some of the possible implementations of rules to automatically enforce certain policy or contractual obligation of the theatre, e.g., to not show advertising for a competing beverage.

The rule in row 541 disallows a SPL or PPL that references CPLs having an ID value of 88888888-8888-8888-8888-888888888888, as composition reference 320 does in CPL_Id 322. Similarly, row 542 disallows a SPL or PPL that references compositions having annotation text with the phrase “Sippy Cola” (a competing beverage). Thus, either row 541 or row 542 would forbid the showing of composition reference 320 in PPL 300.

The rule in row 543 disallows a CPL whose ID is 88888888-8888-8888-8888-888888888888, which is similar in effect to row 541. Row 544 disallows any CPL whose content title text contains “Sippy Cola” and rows 545 and 546 disallow any CPL whose issuer is “Sippy Beverage Company” or containing the text “Sippy”, respectively.

Thus, any one match (i.e., a test result of “true”) from rows 541-546 may be sufficient to exclude CPLs that advertise a product with the term “Sippy”, but one or more of rows 541-546 may be needed to automatically detect and reject a majority of such advertisements. It is also possible that additional rules (i.e., represented in additional rows, not shown) may be needed to achieve total compliance with one or more policies, and the tests may also involve entries relating to metadata within or about the CPL, whether or not mentioned herein.

The rules expressed in rows 541 and 543 exclude a specific version of an advertisement. Such rows might be added to theatre policy section 540 as a result of a theatre manager identifying that a particular advertisement violates a theatre policy. Row 547 excludes all composition playlists having the same content version identifier of a specific advertisement, and would therefore be generally preferred to row 541 or 543 as a means of excluding an advertisement from the theatre's screens. Note that a content version ID identifies a composition according to its content, e.g., a commercial in different languages will have different content version IDs. For a commercial with a given content version ID, if the composition is updated, e.g., to correct a bad edit, data error, or a mis-statement (but the content itself is mostly the same, e.g., it is the same commercial in the same language intended to replace the uncorrected commercial), the updated composition will be identified by a different CPL ID, with the content version ID remaining the same.

Rows 542, 544, 545, and 546 all attempt to reject compositions based on one or more words (e.g., used in a company name, product name, or brand name) in the title text, annotation text, or issuer name of a CPL. Such exclusions may also be constructed using other or additional metadata that are known or may become available in the future.

Thus, when an attempt is made to run SPL 200, and PPL reference 230 causes PPL 300 to be incorporated into the show, composition reference 320 will be skipped on the basis of, for example, row 541, whose comparison or test returns a “true” value (i.e., composition reference 320 has a CPL_Id 322 value that equals the forbidden value 530 in row 541).

In the exemplary SPL 200, PPL 300, and CPL 400 and to the extent shown in FIGS. 2-4, no other CPL will be rejected by section 540 of forbid list 500.

In this example, policies in section 550 are applicable to playlists identified by a designation 560, e.g., “Matinee”. A match between designation 560 and the contents of annotation text 208 of SPL 200 indicates that section 550 of forbid list 500 is applicable.

In another embodiment, designation 560 may include the rating (not shown) to be matched by the feature composition reference 260. The rating criterion may be included in designation 560 in place of, or in addition to, the “matinee” requirement. Other criteria (not shown) may be used to determine whether a section 550 is applicable to a SPL 200.

This designation field 560 is a convenient mechanism to specify one or more criteria for the applicability of the rules in section 550. These criteria can also be considered as additional rules, except that they apply at a higher priority (e.g., as a initial filter) compared to the individual rules represented in the respective rows. Thus, different sets of rules may be specified for different playlists satisfying the criteria in the designation field 560. Such an evaluation can be performed by examining one or more fields (which can be predetermined, or explicitly listed in section 550) in the playlist for possible match with the designation 560.

By extension, since PPL 300 is referenced from within SPL 200, if a section 550 applies to SPL 200, it is preferably also applied to PPL 300 (unless PPL 300 is already excluded by other criteria previously mentioned or applied).

The playlist policies section 550 provides rules (represented by rows 551-552) that are applied in addition to those in section 540. Note that the order in which sections 540 and 550 are applied may also be reversed. In this example, rules in section 540 are applicable to SPL 200 because it matches the designation 560 (the text “matinee” is contained within annotation text 208 of SPL 200).

In addition to, or in place of, the “AnnotationText” field illustrated above, other metadata (not shown) relating to one or more playlists may also be used as a field to test for a match against the value or characteristics specified in designation 560.

If a match is found between designation 560 and metadata related to SPL 200, then all PPLs and CPLs that are included or referenced in SPL 200, either directly or indirectly (e.g., through other PPLs or CPLs) will have a match with designation 560. In this example, PPL 300 (included in SPL 200) contains composition reference 330 having CPL_Id 332 that matches ID 406 of CPL 400. Thus, CPL 400, if not previously rejected by other rules, will be tested against the rules in rows 551-552.

Rules in rows 551 and 552, respectively, eliminate CPLs having a rating of “R” or “PG”. In the case of CPL 400, one of the rating labels (label 444) matches the “R” rating in row 551. Thus, CPL 400 would be excluded from the playout of matinee show playlist 200.

Alternatively, row 551 can also specify a compound requirement that a composition rating have both an agency element that contains “mpaa” and a label element that contains “R”. This alleviates an ambiguity that might occur should different agencies have differing meanings for the same labels.

In an alternative embodiment, designation 560 may be further compared with schedule information (not shown) for a match, e.g., for shows prior to 5:00PM, or for the last show of the evening. This option may be used to skip or omit advertisements promoting popcorn and beverage sales after the concession stand has closed.

In still another embodiment, the existence of other metadata (not shown, including those that may not be presently available) could be exploited, for instance when examining a CPL classified as a trailer, any trailer (regardless of its own rating) associated with a feature having a rating of “R” might be excluded from a show, e.g., based on the metadata of the trailer, which may cite the associated feature as being R-rated. Thus the capability of the present invention would drive the development of and demand for additional metadata.

More complex criteria or logical operators may also be encoded into forbid list 500. For example, each entry in forbidden value 530 may include a list of values, such that matching any one value (i.e., returning a “true” value to a comparison test against the given values), would constitute a match for that row or satisfying the rule represented by that row. Thus, rows 551 and 552 may be combined into a single row having a forbidden value 530, in list form, of {“R”, “PG”}, which serves to exclude any CPL with a rating of “R” or “PG”.

In still another embodiment, several criteria or tests may be included in one rule (or row) in the forbid list 500, all of which are required to be satisfied before a composition is rejected based on that rule. For example, a rating of “PG” plus an additional metadata type (not shown) that indicates that the reason for the rating is due to something other than “cartoon violence.” This example represents a policy by the theatre to exclude PG content, but not those instances where the PG rating was received for depictions of cartoon violence.

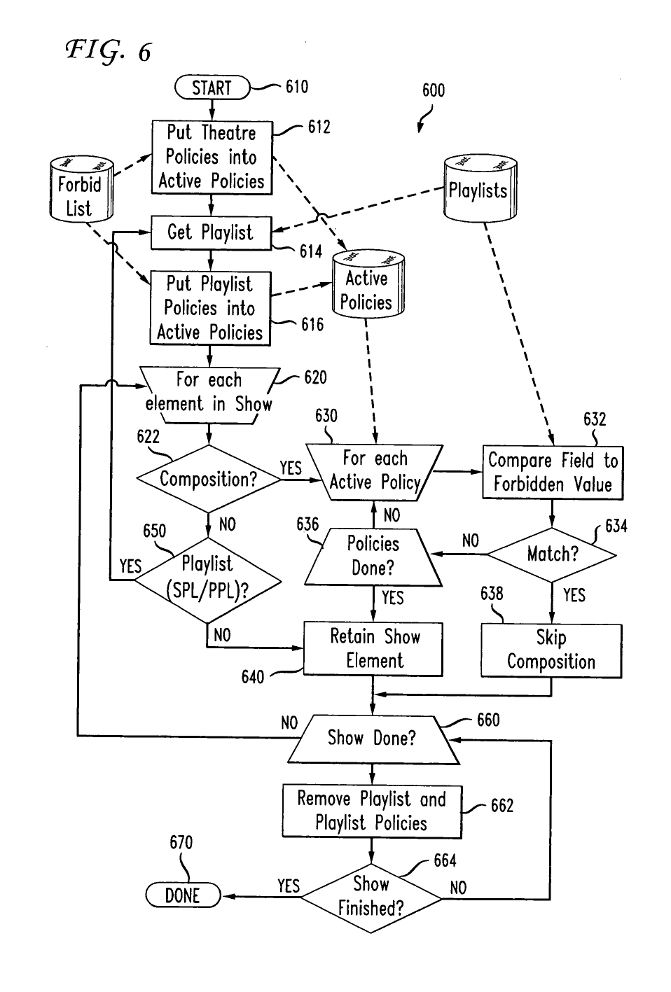

FIG. 6 illustrates a method 600 for processing a playlist according to one or more rules, e.g., provided in a forbid list 500, to exclude certain composition playlists from being played out. Method 600, for example, can be used to automatically enforce an exhibitor's policies relating to the display of media content. This may be referred to as a policy adherence or enforcement method, and is preferably performed by one or more components in a theatre management system, or in a digital cinema server, or a combination thereof.

Method 600 starts at step 610, in which a list of active policies is cleared, so that in a subsequent step 612, theatre policies can be added to the list of active policies for use in processing any show playlist. The theatre polices 530 are always active for a given theatre, and apply globally to all SPLs. The theatre policies may be represented by rules provided in section 540 of forbid list 500 of FIG. 5.

On first entry into a playlist fetch step 614, a playlist is retrieved from storage (e.g., storage 140 associated with server 110 of FIG. 1). The playlist may be a show playlist, pack playlist or composition playlist, e.g., SPL 200, PPL 300, or CPL 400 of FIGS. 2-4.

In step 616, new policies (e.g., playlist policies) are added to the list of active policies. This can be done, for example, by checking whether the playlist retrieved in step 614 matches any designation in a playlist policy section of a forbid list (e.g., checking against designation 560 of a playlist policy section 550 of FIG. 5). For all playlist policy sections with designations matching the retrieved playlist, rules represented in the forbid list (preferably not duplicating those already in the active policies list) are added to the active policies list. Unlike the theatre policies, playlist policies are applicable to a specific SPL and any nested playlists, i.e., any SPLs or PPLs included or referenced in that specific SPL.

In one embodiment, the entirety of rules added to the active policies list in a single visit to step 616 are effectively “pushed” (in computer terminology) onto the actively policies list, as onto a stack. Although a stack structure is used in this example, in which a rule is added to or removed from the stack in a “last-in first-out” manner (hence, the “push” and “pop” terminologies), other embodiments can also be implemented without requiring the use of the stack structure.

With all of the rules representing the applicable exhibitor policies residing in the active policies list, a loop (formed by steps 620 and 660) is entered at step 620 that iterates over all of the current playlist's show elements.

In composition test step 622, a determination is made as to whether the element of the show is a CPL reference. If not, processing continues at step 650. Otherwise, an inner loop (formed by steps 630 and 636, and containing steps 632, 634) is entered at step 630 to test the CPL reference against each of the rules representing the active policies.

In comparison step 632, the CPL reference is tested against the current active policy, e.g., comparing the appropriate field of the CPL with a forbidden value corresponding to each rule. If necessary, the CPL reference can be used to fetch the corresponding CPL itself (e.g., from storage 140 of FIG. 1) for comparing with the forbidden value.

In step 634, a determination is made as to whether the CPL reference or the CPL itself matches the forbidden value. If a match exists, the show element (e.g., composition represented by the CPL) is skipped in step 638 and will not be included at this time in the show playlist. In this case, once a CPL has been matched to a rule (e.g., satisfying a test by matching a forbidden value in the rule), the CPL is no longer subjected to additional checking against the remaining rules in the applicable section. Furthermore, a record or report can also be made that the particular CPL has been skipped, and the basis for this action, e.g., citing the rule for which a match has been found.

If there is no match in step 634, then a loop check is made in step 636 to determine whether there are active policies remaining to be checked against the CPL reference or CPL. If so, the loop iterates to step 630. If not, the loop exits to step 640, at which point the current show element is retained at this time in the show playlist.

After the show element is retained in step 640 or excluded in step 638, processing continues at loop check step 660, in which a determination is made as to whether all the show elements in the current playlist have been processed. If so, handling of the current playlist (e.g., SPL, PPL) is complete and processing continues with step 662, in which the rows implementing activated policies (added in step 616) in conjunction with the just-finished playlist are removed (or, in computer terms, “popped”) from the active policies list.

Processing continues with step 664, in which a determination is made as to whether all the show playlists have been processed. If no playlist remains, as would be the case unless a pack playlist has been encountered in the playlist, processing concludes at step 670.

However, if a pack playlist (PPL) has been encountered (as discussed below in connection with step 650), and only now (at step 660) is its handling or processing complete, then the completion of the PPL handling also requires a removal of its playlist policies from active policies and a removal of the playlist (since it is no longer the current playlist), as performed in step 662. At completion test step 664, the process returns to loop check step 660 to continue handling the current playlist that has referenced this PPL (this playlist may be the SPL, or a nested PPL, if supported). Thus, the removal of the PPL and the return to step 660 resumes iteration of its parent SPL immediately after the point where the just-removed PPL is referenced.

Referring back to step 622, if it is determined that the current show element is not a composition, then processing continues at playlist test step 650. If step 650 determines that the current show element is not a SPL or PPL (e.g., a marker used to trigger auditorium automation systems), then the show element is retained in step 640.

If playlist test step 650 determines the current show element is a playlist reference, e.g., SPL or PPL (nested within the current SPL or PPL), then a recursive call is made to fetch step 614 (from which the return includes steps 662 and 664). In so doing, the playlist identified by the playlist reference (whether implemented as an SPL or a discrete PPL format) is retrieved from playlist storage and processing continues at step 616, in which additional rules are added or registered to the active policies for further processing. When the processing of this nested SPL or PPL is completed at step 660, this nested playlist and corresponding rules will be removed in step 662, and the parent list will again be tested in step 664 to see if processing of its elements is complete (if not, the method returns to step 660 again). If there is no nesting of playlist in a SPL, then steps 622, 650, 662, and 664 may be omitted.

Thus, method 600 is able to read a show playlist, apply the appropriate policies as expressed in a forbid list to determine whether each composition is appropriate, and recursively handle each pack playlist (if any), applying additional policies appropriate to them, whereby the exhibitor's policies as expressed in the forbid list are automatically applied to the entirety of the expanded show playlist.

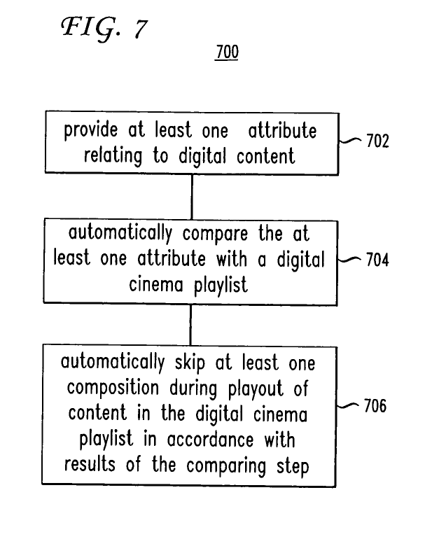

FIG. 7 shows another embodiment, method 700, for use in a digital cinema, in which a playlist is processed for presenting digital content related to the playlist. In step 702, at least one attribute (or characteristic) related to the digital content is provided. In one embodiment, one or more attributes are provided in a list such as a forbid list or skip list (e.g., as forbid values), or as values or terms specified in a designation field (e.g., designation 560), as described in connection with FIG. 5. Such attributes may include, for example, playlist identifier, an annotation text, an issuer of a playlist, a content title, a content version, a rating, and language, among others. In step 704, a composition playlist in a digital cinema playlist is compared to the attribute, e.g., by examining one or more fields in the composition playlist with characteristics corresponding to the attribute. Alternatively, a composition itself (which may include the CPL and all its referenced files) may be examined or compared to the attribute in step 704. This may be useful in situations where the metadata within the files references by the CPL may be of interest, e.g., an audio file may have metadata that is not duplicated in the CPL that references the audio file.

In step 706, if a match is found between a field in the composition playlist and the attribute, the composition referenced in the playlist is skipped (i.e., omitted from presentation) during playout of the digital cinema playlist.

There are several possible implementations of this method. In one embodiment, the comparison step is performed before a scheduled presentation of the content in the original playlist, e.g., a SPL. If the comparison shows a match between any composition and the attribute(s), a modified or revised playlist (with the “matched” compositions omitted) is stored in the server for later retrieval and presentation.

In another embodiment, the comparison step is performed before a scheduled content presentation. However, instead of creating and storing an entire revised SPL, only the specific PPLs or CPLs containing the compositions to be skipped are stored as revised PPLs or CPLs. The SPL remains unchanged, and when processed during playout, will cause the revised PPLs or CPLs to be presented (i.e., assuming that the SPL references the PPLs or CPLs by appropriate version identifiers, instead of the specific PPL ID or CPL ID), instead of the original CPLs. Note that the original PPLs or CPLs do not have to be deleted or replaced by the revised PPLs or CPLs, because there may be other SPLs (executing different rules) that would use the original PPLs or CPLs. In addition, it is also possible that the same SPL (now using the revised PPLs or CPLs), when executing at a different time of day, may trigger differently and use the original PPLs or CPLs instead.

In yet another embodiment, the comparison step is performed in real-time, i.e., as the show playlist is being processed during presentation. In this scenario, there is no need for storing a revised playlist prior to content presentation.

Another embodiment of the present principles provides a computer readable medium (e.g., memory, storage device, removable media, and so on) with stored instructions, such that, when executed by a processor, will perform a method for processing one or more playlists in accordance with one or more embodiments discussed above. For example, the method may include: providing at least one attribute relating to digital content, automatically comparing a digital cinema playlist with the at least one attribute, and automatically skipping at least one composition during playout of content in the digital cinema playlist in accordance with results of the comparing step.

Yet another embodiment provides a system having a storage means or storage device for storing at least one attribute relating to digital content, and a processing means or processor configured for automatically performing a comparison of a playlist with an attribute, and skipping a composition, in accordance with results of the comparison, during playout of content on the playlist.

While the forgoing is directed to various embodiments of the present invention, other and further embodiments of the invention may be devised without departing from the basic scope thereof. As such, the appropriate scope of the invention is to be determined according to the claims, which follow.

1. A method for use in a digital cinema, comprising:
providing at least one attribute relating to digital content;
automatically comparing the at least one attribute with a digital cinema playlist having references to one or more compositions; and
automatically skipping at least one composition during playout of content in the digital cinema playlist in accordance with results of the comparing step.

2. The method of claim 1, wherein the at least one attribute is one of a playlist identifier, an annotation text, an issuer of a playlist, a content title, a content version, a rating, and language.

3. The method of claim 1, wherein the at least one attribute is provided in a list representing operating policies in the digital cinema.

4. The method of claim 3, wherein the list includes a field in the digital cinema playlist and a test for use in the comparing step.

5. The method of claim 1, wherein the comparing step is performed during one of: editing of the digital cinema playlist and real-time playout of the digital cinema playlist.

6. The method of claim 1, wherein the skipping step further includes:
identifying at least one composition in the playlist that satisfies a condition with respect to the at least one attribute;
creating a revised playlist that excludes the at least one composition; and
playing out digital content from the revised playlist.

7. The method of claim 1, wherein the digital cinema playlist is provided by one of: a content provider and content distributor.

8. A digital cinema system, comprising:
a storage device for storing at least one attribute relating to digital content; and
a processor configured for automatically performing a comparison of the at least one attribute with a playlist having references to one or more compositions, and automatically skipping at least one composition during playout of content in the playlist in accordance with results of the comparison.

9. The system of claim 8, wherein the at least one attribute is one of a playlist identifier, an annotation text, an issuer of a playlist, a content title, a content version, a rating, and language.

10. The system of claim 8, wherein the at least one attribute is provided in a list representing operating policies in the digital cinema.

11. The system of claim 8, wherein the list includes a field in the digital cinema playlist and a test for performing the comparison.

12. The system of claim 8, wherein the processor is further configured for performing the comparison during one of: editing of the digital cinema playlist and real-time playout of the digital cinema playlist.

13. The system of claim 8, wherein the processor is further configured for:
identifying at least one composition in the playlist that satisfies a condition with respect to the at least one attribute;
creating a revised playlist that excludes the at least one composition; and
playing out digital content from the revised playlist.

14. The system of claim 8, wherein the playlist is provided by one of: a content provider and content distributor.

15. A computer readable medium having stored instructions that, when executed, causes a method to be performed; the method comprising:
providing at least one attribute relating to digital content;
automatically comparing the at least one attribute with a digital cinema playlist having references to one or more compositions; and
automatically skipping at least one composition during playout of content in the digital cinema playlist in accordance with results of the comparing step.

16. The computer readable medium of claim 15, wherein the at least one attribute is one of a playlist identifier, an annotation text, an issuer of a playlist, a content title, a content version, a rating, and language.

17. The computer readable medium of claim 15, wherein the at least one attribute is provided in a list representing operating policies in the digital cinema.

18. The computer readable medium of claim 17, wherein the list includes a field in the digital cinema playlist and a test for use in the comparing step.

19. The computer readable medium of claim 15, wherein the comparing step is performed during one of: editing of the digital cinema playlist and real-time playout of the digital cinema playlist.

20. The computer readable medium of claim 15, wherein the skipping step further includes:
identifying at least one composition in the playlist that satisfies a condition with respect to the at least one attribute;
creating a revised playlist that excludes the at least one composition; and
playing out digital content from the revised playlist.
